(19) United States
(12) Patent Application Publication
(10) Pub. No.: US 2007/0029362 A1
(43) Pub. Date: Feb. 8, 2007

(54) Roller and rotational driving device

(76) Inventors: Frederic Caillaud, Feignies (FR); Jacky Deremetz, Neuf Mesnil (FR)

Correspondence Address: Vesuvius USA Corporation;RIDC Park West, 250 Park West Drive, Pittsburgh, PA, 15275, US

(21) Appl. No.: 10/554,361

(22) PCT Filed: Apr. 28, 2004
(86) PCT No.: PCT/BE04/00058

§ 371 Date: Oct. 10, 2006

(30) Foreign Application Priority Data
Apr. 28, 2003 (EP) 034470971

(51) Int. Cl. B65H 20/02; F16C 13/00

(52) U.S. Cl. 226/188; 492/15; 226/190

(57) ABSTRACT

The invention relates to a roller from a refractory material, for example in vitreous silica, for transporting a flat article provided at its end with a new arrangement for rotationally driving it as well as to an assembly of such a roller and its driving device. This roller comprises an external surface and two side surfaces, at least one side surface having indentations for receiving rotationally driving pins, it is characterized in that the openings of said indentations which extends in the radial direction of the roller are spaced apart from the external surface of the roller and in that the indentations have a cross-section which is larger in the radial direction of the roller than in the tangential direction. The invention permits to avoid the breakage of the roller around the driving indentations.

The invention relates to a roller from a refractory material, for example in vitreous silica, for transporting a flat article provided at its end with a new arrangement for rotationally driving it as well as to an assembly of such a roller and its driving device.

In the glass or metallurgical industry, the conveyance of glass or metal in the course of being elaborated and under the form of plates, sheets, foils or continuous strips, is carried over on rollers arranged parallel together. This transportation is generally performed at high temperature.

These rollers are rotationally driven at a liner speed equal to this of the glass or metal so as not to damage the surface.

More particularly, in the case of the transportation of a metal strip or band, every roller is supported on a steel shaft passing through an axial bore of the roller and projects beyond the roller at its both ends, ensuring simultaneously its rectilinear support and its centering during the rotation. To this end, this axial bore presents a smooth cylindrical longitudinal inner surface which is precisely coaxial to the external longitudinal face of the roller and shows a predetermined diameter.

Generally, the rotational driving of the roller is ensured by a driving device comprising fingers parallel to the shaft, arranged around each of the ends thereof and borne by a support rotating with the shaft. Every pin engages into a recess formed in the lateral face of the roller, i.e. in the thickness of the roller which is comprised between the longitudinal bore and the external longitudinal face. There is however also a driving device using pins perpendicular to the shaft. Such a device is disclosed in the document WO-A1-99/15305. It can be easily understood that such a system cannot perform efficiently when the roller and the driving device are formed from materials having different thermal expansion coefficient.

As a variant of the conventional device, a roller whose lateral faces are provided with one or more recesses opening on the external surface of the roller is known from the document JP-A-10-324534.

A defect which can appear with such a driving device acting on such rollers is that the edge of the roller, weakened by the presence of the recesses, is broken in its part comprised between the recess and the axial bore. In particular, during use of the roller, the increase in temperature to which the roller and the driving device are subjected causes significant dimensional differences which increase the risk of break of the roller around its driving recesses.

While such a defect is not directly detrimental to the proper performance of the roller, the presence of silica fragments close to the metal being conveyed, to the driving device or even inside the longitudinal bore can become worrying.

This defect occurs in particular on small diameter rollers, for example of 120 mm, inside which there remains rather little matter between the bore and the recesses.

The present invention aims at remedying this defect by proposing a new arrangement for rotationally driving a roller.

A roller whose the driving indentations extend through the whole roller side surface and open thus both on the external surface of the roller and on the longitudinal inner surface is known from the document JP-A-1-312026. These rollers are weakened and, consequently, are quickly damaged at the level of their side surfaces.

According to the invention, it is meant by pin any means able to engage into an indentation of the roller to transmit a rotation couple. This term comprises the above described fingers.

The present invention has for first object a roller from a refractory material for transporting a flat article, according to claim 1.

The present invention also relates to an assembly comprising:

such a roller and

a driving device comprising pins borne by a rotary support and able to engage in the roller indentations,

said assembly being characterized in that at least one pin and the Indentation which receives the pin are formed so that a significant play, according to a radial direction of the roller, stands between the pin and the indentation when said pin has engaged into the said indentation.

The invention remedies the above indicated problem by leaving a significant play between the pin and the indentation in the radial direction of the roller, i.e. in a direction passing through the roller axis.

It is meant by significant play a free space permitting the movement of the pin, on a stroke larger than the play only due to the manufacturing tolerances, as well as to a functional play necessary for engaging the pin into the indentation. The significant play is advantageously selected so as to permit a pin movement in the indentation during the temperature changes occurring during the use of the roller. To this end, the play is of at least 3 mm. Preferably, this play is larger than 4 mm.

According to a particular embodiment of the invention, the roller comprises an axial bore having an inner longitudinal surface and the indentations open also on this inner longitudinal face.

This embodiment has the advantage that, close to the indentation, there is no longer a region with matter weakened by its low thickness. In other words, rather than leaving on the roller a thin layer of matter capable of breaking, it is eliminated right away so as to avoid the production of undesirable fragments.

Advantageously, the longitudinal inner surface is a bearing surface of the roller with which the roller bears on a bearing shaft. The external face of the roller remains intact and continuous which can prove preferable in particular applications wherein the whole width of the roller is used for transporting the article in the course of being elaborated. On the other hand, since the indentations do not extend through the whole surface of the roller, the side surfaces are not weakened.

According to a variant, only some of the indentations open on the inner longitudinal surface. Preferably, the indentations are arranged symmetrically with respect to the roller axis. This variant presents the advantage to permit a perfect driving of the roller both while cold (at the beginning of the conveying operations) and while hot (once the driving pins have reached their working temperature). Thereby, at the beginning of the conveying operations, pins engaged in indentations without opening on the inner surface and almost in contact with the bottom of the roller avoid the clinking phenomenon (bounce on the pin). When the regime temperature is reached, these pins, by thermally extending, move away radially from the corresponding indentations bottom. On the contrary, the pins engaged into indentations opening on the inner face are also thermally extended and therefore are closer to the bottom of the corresponding indentations and are now almost in contact with it ensuring thereby a similar function while hot.

According to a particular embodiment of the invention, at least one indentation is delimited by at least delimited by at least two walls contained in planes passing through the rotation axis of the roller. In this embodiment, the corresponding pin of the driving device presents advantageously the same geometric feature, i.e. it comprises at least two walls contained in planes passing through the rotation axis of the pins rotary support.

This particular configuration of the indentations and pins provides a better distribution of the whole bearing surface between the driving device and the roller which contributes to the reduction of the stress concentration risk on the edges of the roller.

In order to facilitate the understanding of the invention, embodiments will now be described, only as examples which do not limit the scope of the invention, with the help of the enclosed figures wherein:

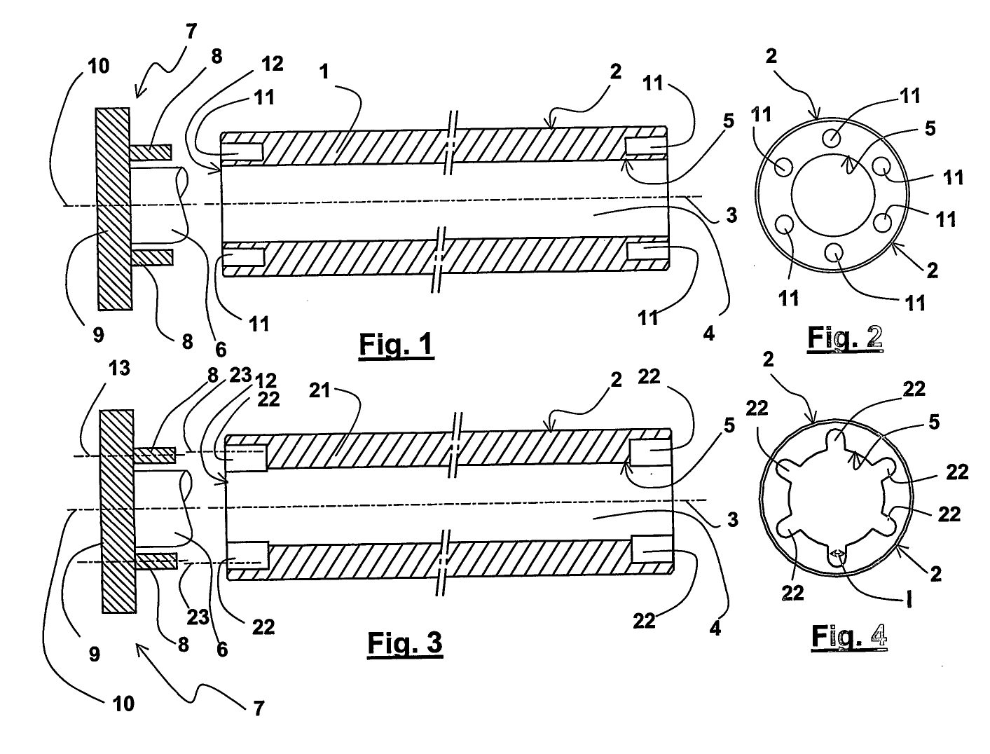

FIG. 1 is a longitudinal section of a vitreous silica roller used for transporting glass, according to the prior art;

FIG. 2 is a left view of the prior art roller of FIG. 1;

FIG. 3 is a view similar to FIG. 1 of a roller according to a first embodiment of the invention;

FIG. 4 is a left view of the roller of FIG. 3;

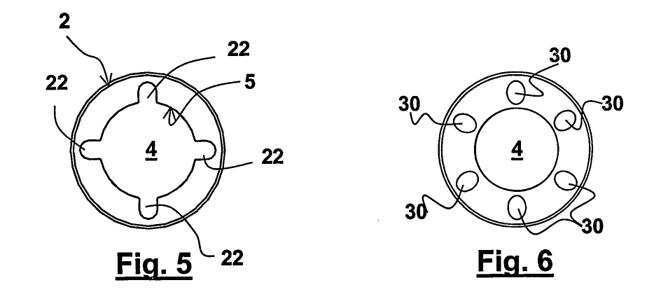

FIG. 5 is a view similar to FIG. 4 of a roller according to a second embodiment of the invention;

FIG. 6 is a view similar to FIG. 4 of a roller according to a third embodiment of the invention.

On the drawings, the elements are depicted at ambient temperature, i.e. in the position they occupy when the roller is not in use for transporting glass. The thermal expansions of the hot elements cause relative displacements between the elements which are not depicted here.

In the prior art, which is illustrated by FIGS. 1 and 2, a roller 1 of cylindrical shape is made from vitreous silica by a known process.

This roller has a length of several meters and a diameter which, according to the type of roller, can be comprised between 10 and 20 centimeters.

An external longitudinal surface 2 of the roller serves as bearing surface for glass (not shown) in the process of being elaborated which is transported with several rollers of the same kind arranged parallel together.

The glass rolls on the external longitudinal surface 2 of the roller which, to this end, must have a very smooth surface and a very cylindrical shape of axis 3.

An axial bore 4 is formed inside the roller, coaxial with the external longitudinal surface 2. The precisely cylindrical shape of the wall 5 of the bore 4 is obtained by a precise machining which ensures that this inner longitudinal surface has a cylindrical shape of the same axis 3.

The bore 4 permits the passage of a bearing shaft 6 (partly shown) which maintains the roller rectilinear and supports it by the bearing surface 5, while allowing its rotation.

The rotational driving of the roller 1 is ensured, as is well known, by a driving device 7 present on both ends of the roller but of which only one half, shown on the left of the roller on the figure is described here.

The driving device comprises six driving fingers 8, parallel to the axis 3 and borne by a support 9 rotarily mounted around an axis 10 which merges with the axis 3 when the roller is mounted on the driving device.

In the example shown, the bearing shaft 6 is integral with the rotary support 9, but another arrangement could leave it separate from the rotary support since the shaft is not intended to drive the roller in rotation.

The six fingers 8 are regularly distributed around the bearing shaft 6 and correspond to six indentations 11 formed in the thickness of the roller on its end side surface 12 located in front of the driving device.

The length of the fingers 8 and the indentations 11 is selected long enough so that, despite the differential thermal expansions of the shaft and the roller, the fingers keep a part of their length inside the indentations sufficient to transmit to the roller the required couple without twisting.

The diameter of each indentation 11 is slightly larger than that of the corresponding driving finger 8, so that the fingers can easily slide into the indentations both when the roller is assembled and during the thermal variations of the assembly, the support expanding more than the roller.

The driving device constituted by the support 7 and the driving fingers 8 combined to the indentations 11 fulfills therefore a driving function which is dissociated from the supporting function assigned to the bearing shaft 9.

It can be seen that the roller exhibits the risk that the thin part of matter present between each indentation 11 and the axis 3 be destroyed during the use of the roller.

A roller according to a first embodiment of the invention will now be described with reference to FIGS. 3 and 4.

On all these figures, the reference numbers previously used designate the same elements as these already described.

A roller 21 comprises a longitudinal external surface 2 and an inner longitudinal surface 5 delimiting an axial bore 4. The external and inner longitudinal surfaces 2 and 5 are coaxial, they share the same axis 3.

The indentations 22 formed on the lateral end faces 12 of the roller are opened towards the axis 3 while emerging on the whole length of the inner longitudinal surface 5.

In cross-section, as shown on FIG. 4, each indentation is U-shaped with a width 1 equal to its diameter in its rounded part, diameter which is slightly lower than that of the fingers 8 of the driving device. This width represents also the transversal cross-section in the direction tangential to the indentation which, as can be seen, is lower than the transversal cross-section in the radial direction of the roller (perpendicular to the tangential direction).

Unlike the state of the art, the axis 23 of the rounded part of each Indentation 22 is more remote from the axis 3 than the axis 13 of each finger 8 is remote from the axis 10 on the driving device. Thereby, when the driving fingers 8 are engaged into the indentations 22, there remains a play in the radial direction of the roller, i.e. in the direction passing through the axis 3 or 10, 13 and 23 (the plane of FIG. 3 is one of these radial directions), between each finger 8 and the bottom of the corresponding indentation 22.

At the opposite of the indentations bottoms, i.e. in the direction of the axis 3, the absence of matter leaves a free-space for the radial clearance of the fingers 8, resulting from the differential thermal expansions occurring during the use of the roller.

Thereby, the risk that a thin part of matter present between each indentation 11 and the axis 3 be destroyed during the use of the roller is discarded.

In a variant not shown, the fingers 8 are In contact with the bottom of each indentation 22 as in the prior art. In this case, the axis 13 and 23 merge, but there remains yet a radial play between the fingers and the axis 3 due to the absence of matter.

In the above described example, the driving device 7 and the roller 21 comprise respectively six fingers 8 and six indentations 22.

One would not depart from the scope of the invention by varying this number, provided the integrity of the roller is respected during the transmission to this last of a rotary moment. FIG. 5 depicts a second embodiment wherein the number of indentations 22 is four.

In the third embodiment of FIG. 6, each indentation 30 shows, in cross-section an elongated shape whose the two rounded parts have axis which are radially spaced from a length greater than the stroke between each finger during the differential thermal expansions between the driving device and the roller.

This embodiment is only possible if the roller has a diameter great enough so that enough matter remains on both sides of each elongated indentation, according to the radial direction of the roller, to avoid its destruction and the production of fragments.

In all the described examples, the indentations section is greater in the radial direction of the roller than in its tangential direction and the opening of the indentations is spaced apart from the external surface of the roller.

Eventually, according to an advantageous embodiment of the invention, at least one of the indentation is provided with a metal jacket. Thereby, the stress and the shocks caused by the driving device are homogeneously distributed. In this case, the jacket is constituted of a metal pipe adjusted into the indentation. Advantageously, this pipe is slit longitudinally so as to provide some elasticity.

It should be understood that any desirable modification could be brought to the above described example without departing thereby from the scope of the invention.

What is claimed is:

1-8. (canceled)

9. A roller made of refractory material, comprising an external surface and two side surfaces, at least one side surface having indentations for receiving rotationally driving pins, wherein the openings of said indentations which extends in the radial direction of the roller are spaced apart from the external surface of the roller and wherein the indentations have a cross-section which is larger in the radial direction of the roller than in the tangential direction.

10. A roller according to claim 9, further comprising an axial bore having an inner longitudinal surface, wherein the indentations open also on the inner longitudinal surface.

11. A roller according to claim 10, wherein the inner surface is a bearing surface of the roller with which the roller bears on a bearing shaft.

12. A roller according to claim 9, wherein at least one indentation is delimited by at least two walls contained in planes passing through a rotation axis of the roller.

13. A roller according to claim 9, wherein at least one indentation is provided with a metal jacket.

14. A roller according to claim 13, wherein the metal jacket is constituted of a metal pipe.

15. A roller according to claim 14, wherein the metal jacket is constituted of a longitudinally-slit metal pipe.

16. An assembly comprising:
(a) a roller according to roller of refractory material, comprising an external surface and two side surfaces, at least one side surface the openings of said indentations which extends in the radial direction of the roller are spaced apart from the external surface of the roller and wherein the indentations have a cross-section which is larger in the radial direction of the roller than in the tangential direction; and
(b) a driving device comprising pins borne on a rotary support and able to engage in the roller indentations;
wherein at least one pin and the indentation which receives the pin are formed so that a play, according to a radial direction of the roller, of at least 3 mm stands between the pin and the indentation when said pin has engaged into the indentation.
